(19) United States
(12) Patent Application Publication
(10) Pub. No.: US 2019/0091636 A1
(43) Pub. Date: Mar. 28, 2019

(54) POROUS THIN-FILM MEMBRANE, METHOD FOR PRODUCTION THEREOF AND ALSO POSSIBILITIES OF USE

(71) Applicants: FRAUNHOFER-GESELLSCHAFT ZUR FÖRDERUNG DER ANGEWANDTEN FORSCHUNG E.V., München (DE); RHEINISCH-WESTFÄLISCHE TECHNISCHE HOCHSCHULE (RWTH) AACHEN, Aachen (DE)

(72) Inventors: Himanshu CHARAN, Potsdam (DE); Ulrich GLEBE, Potsdam (DE); Alexander BÖKER, Berlin (DE); Murat TUTUS, Potsdam (DE); Ulrich SCHWANEBERG, Kelmis-Hergenrath (BE); Leilei ZHU, Aachen (DE); Marco BOCOLA, Aachen (DE); Tayebeh MIRZAEIGARAKANI, Aachen (DE); Julia KINZEL, Aachen (DE); Deepak ANAND, Aachen (DE)

(73) Assignees: FRAUNHOFER-GESELLSCHAFT ZUR FÖRDERUNG DER ANGEWANDTEN FORSCHUNG E.V., München (DE); RHEINISCH-WESTFÄLISCHE TECHNISCHE HOCHSCHULE (RWTH) AACHEN, Aachen (DE)

(21) Appl. No.: 16/085,250

(22) PCT Filed: Mar. 1, 2017
(86) PCT No.: PCT/EP2017/054764

§ 371 Date: Sep. 14, 2018

(30) Foreign Application Priority Data
Mar. 16, 2016 (EP) 16160714.8

(51) Int. Cl. B01D 69/14; B01D 71/80; B01D 67/00

(52) U.S. Cl. CPC B01D 69/144; B01D 2323/30; B01D 67/0006; B01D 71/80

(57) ABSTRACT

The subject of the invention is new membranes in which tailor-made membrane transport proteins (such as e.g. TCDB classified proteins) act as pore-forming proteins (e.g. FhuA) or peptides which act as pores in the membrane. The membranes can preferably be produced both by linking synthesised protein-polymer conjugates and by direct linking of the pore-forming proteins and peptides. Such membranes are distinguished by many outstanding features which existing membranes have not been able to offer to date.

The subject of the invention is new membranes in which tailor-made membrane transport proteins (such as e.g. TCDB classified proteins) act as pore-forming proteins (e.g. FhuA) or peptides which act as pores in the membrane. The membranes can preferably be produced both by linking synthesised protein-polymer conjugates and by direct linking of the pore-forming proteins and peptides. Such membranes are distinguished by many outstanding features which existing membranes have not been able to offer to date.

One class of optically active compounds (“chiral”) is enantiomers. Of these, two forms, the mirror images of which are identical, exist, which however cannot be made congruent. A very concrete example is the right and left hand of a human. For many applications, an enantiomer-pure compound is however required, i.e. only one of the two existing forms. Since however these are frequently present in a mixture (in the case of a 1:1 mixture, this is called a racemate) and behave the same chemically, a series of promising methods has been developed in order to separate an enantiomer mixture. Enantiomer-pure compounds are required for medicines, food additives, scents and many more.

By means of asymmetrical synthesis, an enantiomer form can be directly synthesised. The disadvantages thereby are that often no asymmetrical synthesis exists and the development thereof is associated with high costs and also low yields are present.

For separation of such a mixture, there exist at present four essential methods. The review “Membranes and membrane processes for chiral resolution”, Chem. Soc. Rev. 2008, 37, 1243 offers an overview in this respect. Most of the presently applied separating methods are either cost-intensive or inefficient. The preferred crystallisation of an enantiomer is suitable only for approx. 5-10% of the racemates.

In addition, one form can be isolated by using different reaction rates of both enantiomers with a chiral unit. This is however inefficient and not applicable in all cases.

Chromatographic separation is in fact widely applicable but expensive and inefficient.

Membrane-based separation has the advantages of low costs, high capacity, continuous implementation and no special apparatus being required. Both enantio-selective and non-enantio-selective membranes exist already for separation of enantiomer mixtures, however these differ basically from the membranes according to the invention which are described here. Theoretical works propose a functionalised graphene layer as alternative method for enantiomer separation (Applied Chem. Int. ed. 2014, 53, 9957).

All of the previously mentioned methods are however either cost-intensive or restricted to a small substance quantity.

There are known from the state of the art, for example from US 2011/0046074 A1, membranes in which channel proteins are integrated. The pore-forming proteins and peptides are thereby however not integrated covalently in the polymer matrix which forms the corresponding membranes so that the stability of such membranes is low. In addition, the corresponding membranes are prescribed only for water treatment.

In the expert literature, the insertion of pore-forming proteins and peptides into thin polymer membranes of polymersomes and the subsequent spreading to form planar membranes is described (Small 2012, 8, 1185). Direct linking of pore-forming proteins or peptides or their conjugates has not however been described to date.

It is therefore the object of the present invention to produce stable and highly functional polymer membranes with high pore density which are intended in addition to be usable in varied ways. The membranes should hereby combine, inter alia, a simply and economic implementation of the separation of enantiomer mixtures with a high throughput.

This object is achieved, with respect to a porous thin-film membrane, by the features of patent claim 1, with respect to a method for production of a corresponding thin-film membrane, by the features of patent claim 12 and also, with respect to corresponding possibilities of use, by the features of patent claim 18. The respective dependent patent claims thereby represent advantageous developments.

The present invention hence relates to a porous thin-film membrane, made up of covalently crosslinked, pore-forming proteins and peptides which form continuous pores in the thin-film membrane.

The particular advantage of covalently crosslinked, pore-forming proteins or peptides as pores in membranes resides in the fact that the proteins form uniform pores in the membrane, which can be functionalised also, furthermore, and consequently allow numerous applications. The membranes can be produced simply in an energy- and resource-saving manner. The efficiency of the membranes is high because of a high flow on the basis of the large number of channels and the very thin film thicknesses. Hence, both economical and efficient membranes can be produced. Such membranes are alternatives to existing systems for e.g. the separation of enantiomer mixtures.

The principles underlying the present invention make use of existing, industrial-scale syntheses which can be adapted, for example, exclusively to simple isolation of the desired enantiomer.

Membranes with a substantially higher density of pore-forming proteins or peptides can thereby be produced than via insertion in polymersome membranes. Furthermore, a planar membrane is constructed from the outset via direct linking and can be used directly for applications.

The pore-forming proteins or peptides serve as single uniform pores in the membrane; other methods, in the current state of the art, do not allow the production of exactly identical pore sizes in the range of a few nm diameter. In addition, in the described approach, the density of the pore-forming proteins or peptides in the membrane is very high, which likewise cannot be ensured via other methods. The proteins can both be modified in the inside and outside so that different functionalities can be introduced into the membranes. In this way, membranes can be produced with which, because of a very specifically configured channel interior, an enantiomer mixture can be separated.

By means of the covalent crosslinking, it is possible that very high pore densities which are caused by the respective pore-forming proteins or peptides can be achieved. Preferred pore densities of the thin-film membranes according to the invention are thereby in the range of 1·10⁸ channels/cm² to 1·10¹³ channels/cm².

The pore sizes are thereby caused by the pore-forming protein or peptide used or by a possibly undertaken functionalisation of the pore-forming protein or peptide. Typical pore sizes are thereby in the range of 0.1 to 20 nm, preferably of 0.2 to 10 nm, further preferably of 0.25 to 5 nm and particularly preferably of 0.3 to 4 nm.

It is particularly preferred in the present invention that the pore size of all the pores is essentially identical, in particular the deviation of the pore size being less than 0.04 nm.

The thickness of the thin-film membrane can thereby be in particular between 1 and 100 nm, preferably between 2 and 50 nm, particularly preferably between 3 and 10 nm.

In particular in the case of extremely thin membranes with the above-indicated thicknesses, the result is extremely low throughflow resistance.

Pore-forming proteins and peptides which can be used for the purposes of the thin-film membrane according to the invention are thereby selected in particular from transmembrane proteins and/or proteins of the TCDB classification (http://www.tcdb.org/browse.php) of categories TC #1-9: TC#1) channels/pores, TC#2) electrochemical potential-driven transporters, TC#3) primary active transporters, TC#4) group translocators, TC#5) transmembrane electron carriers, TC#8) accessory factors involved in transport, TC#9) incompletely characterized transport systems. Of preference is class TC#1 channels/pores and in particular class 1.B of β-barrel structure porins, such as for example FhuA of class TC#1.B.14, a representative of the outer membrane receptor (OMR) family). A definition of the TCDB classification is found in Saier M. H., Tran C. V., Barabote R. D.: “TCDB: the Transporter Classification Database for membrane transport protein analyses and information”, Nucleic Acids Res. 34, no. database issue, January 2006, p. D181-D186. For the purposes of the present invention, reference is made to the explanations of this article which is introduced jointly into the disclosure of the present application by reference.

In addition, combinations of two or more of the previously mentioned pore-forming proteins and peptides can be used.

The thin-film membranes according to the invention can be produced preferably in two ways:

On the one hand, by crosslinking of the protein/peptide polymer conjugates which carry correspondingly crosslinkable polymer chains.

A further possibility relates to direct crosslinking of the pore-forming proteins and peptides with a bi- or multifunctional linker.

Both concepts are explained in more detail subsequently.

The previously first-mentioned preferred possibility for production of the thin-film membranes provides that the membrane is produced by the crosslinking of protein/peptide polymer conjugates, the polymers of the protein/peptide polymer conjugates having crosslinkable functionalities and in particular being selected from the group consisting of polymers or statistical copolymers with groups which are crosslinkable by radiation, radical reactions or click-chemical reactions, preferably poly(co)acrylamides and poly(co)acrylates with substituents which are crosslinkable by radiation, radical reactions or click-chemical reactions, in particular poly(co)(N-isopropylacrylamide)(2-(dimethylmaleimido)-N-(ethylacrylamide)), poly(co)(N-isopropylacrylamide)(3,4-dimethylmaleinimidobutylacrylate), poly(co)(N,N-dimethylaminoethylmethacrylate)(3,4-dimethylmaleinimidobutylmethacrylate) or poly(co)(vinylcaprolactam)(3,4-dimethylmaleinimidobutylacrylate).

It is hereby particularly advantageous if the polymers of the protein/peptide polymer conjugates are or become bonded covalently to the pore-forming protein or peptide by means of an initiator, chain-transfer agent or catalyst, which is bonded covalently to the pore-forming protein or peptide, for ring-opening metathesis polymerisation (ROMP) by atom transfer radical polymerisation (ATRP), reversible addition-fragmentation chain transfer (RAFT) polymerisation, nitroxide-mediated radical polymerisation (NMP), ROMP or modified technologies such as activators generated by electron transfer (AGET) ATRP, activators regenerated by electron transfer (ARGET) ATRP, single electron transfer living radical polymerisation (SET-LRP) or supplemental activator and reducing agent atom transfer radical polymerisation (SARA ATRP). For example, succinimidyl-3-(2-bromo-2-methylpropionamido)propionate can be bonded to an amino group of the pore-forming protein or peptide as initiator.

Alternatively the thin-film membranes can be produced preferably likewise by crosslinking of canonical and non-canonical amino acid radicals or glycosylated positions of the pore-forming proteins or peptides by means of at least one bi- or multifunctional crosslinker, the crosslinker being preferably selected from the group consisting of dialdehydes, dicarboxylic acids, N-hydroxysuccinimide-activated dicarboxylic acids, diacid halogenides, diamines and diiso(thio)cyanates such as e.g. 1,3-propiondial, 1,4-butanedial or 1,5-pentandial.

Likewise, it is however possible that both of the previously mentioned reactive principles are applied for production of the thin-layer membranes according to the invention, so that, for example, also pore-forming proteins or peptides directly crosslinked to each other in addition to pore-forming proteins or peptides linked via crosslinked polymer chains are present in the thin-film membrane.

It is likewise possible that the pore-forming proteins and peptide are functionalised on the inner pore surface, in particular by groups which vary the pore size or are provided with charges.

It is furthermore preferred that the thin-film membrane is applied on a porous carrier structure, in particular selected from the group consisting of cellulose nitrate membranes, cellulose acetate membranes, nitrocellulose membranes, mixed cellulose ester membranes, PTFE (polytetrafluoroethylene) membranes, polyethersulphone (PES) membranes, regenerated cellulose membranes, polycarbonate membranes, polyamide membranes and polyacrylonitrile membranes.

The invention relates, in addition, to a method for production of a porous thin-film membrane according to one of the preceding claims, in which the pore-forming proteins and peptides are crosslinked to each other covalently.

According to a first preferred embodiment of the method according to the invention, it is provided
a) that at least one initiator is bonded covalently to each pore-forming protein or peptide via at least one amino acid radical, for example succinimidyl-3-(2-bromo-2-methylpropionamido)propionate is bonded covalently to an amino group of at least one amino acid of each pore-forming protein or peptide,
b) the initiator-, chain-transfer agent- or catalyst-functionalised, pore-forming protein or peptide is brought to react with monomers, protein/peptide polymer conjugates being formed, in which polymers or statistical copolymers with groups which are crosslinkable by radiation, radical reactions or click-chemical reactions, preferably poly(co)acrylamides and poly(co)acrylates with substituents which are crosslinkable by radiation, radical reactions or click-chemical reactions, in particular poly(co)(N-isopropylacrylamide)(2-(dimethylmaleimido)-N-(ethylacrylamide)), poly(co)(N-isopropylacrylamide)(3,4-dimethylmaleinimidobutylacrylate), poly(co)(N,N-dimethylaminoethylmethacrylate)(3,4-dimethylmaleinimidobutylmethacrylate) or poly(co) (vinylcaprolactam)(3,4-dimethylmaleinimidobutylacrylate) are bonded covalently to the pore-forming protein or peptide by means of an initiator, chain-transfer agent or catalyst for ROMP by ATRP, RAFT polymerisation, NMP, ROMP or modified technologies such as AGET ATRP, ARGET ATRP, SET-LRP or SARA ATRP, and subsequently
c) a crosslinking of the protein/peptide polymer conjugates is implemented, in particular by radiation (e.g. UV radiation), radical reactions or click-chemical reactions.

Alternatively or additionally to the previously mentioned procedure, it is likewise possible that the pore-forming proteins and peptides are crosslinked covalently via canonical and non-canonical amino acid radicals or glycosylated positions with at least one bi- or multifunctional crosslinker, preferably a crosslinker selected from the group consisting of dialdehydes, dicarboxylic acids, N-hydroxysuccinimide-activated dicarboxylic acids, diacid halogenides, diamines and diiso(thio)cyanates such as e.g. 1,3-propiondial, 1,4-butanedial or 1,5-pentanedial.

The pore-forming proteins and peptides can for example also be functionalised on the inner pore surface during the procedure according to the invention, in particular with groups which vary the pore size or are provided with charges.

The functionalising of the inner pore surface can thereby be undertaken at any arbitrary point in time of the procedure, for example also before, or else only after the crosslinking.

A further preferred embodiment of the method according to the invention provides that the protein/peptide polymer conjugates or the pore-forming protein and peptides are assembled prior to crosslinking at an interface, the interface representing preferably a liquid-liquid interface or the water/air interface of a droplet on the surface of a porous carrier structure, in particular selected from the group consisting of cellulose nitrate membranes, cellulose acetate membranes, nitrocellulose membranes, mixed cellulose ester membranes, PTFE (polytetrafluorethylene) membranes, polyethersulphone (PES) membranes, regenerated cellulose membranes, polycarbonate membranes, polyamide membranes and polyacrylonitrile membranes.

In particular, the crosslinking and if necessary the binding-on of the initiator, chain-transfer agent or ROMP catalyst and/or the production of the protein/peptide polymer conjugate is effected in aqueous solution. The aqueous solution can thereby have, in addition to water and the reactants, also certain quantities of organic solvents, detergents or surface-active substances.

The polymer matrix of the membranes can be influenced by the use of hydrophobic monomers for the polymerisation, by adjustment of specific temperatures when using thermoresponsive polymers or by changing the pH value when using pH-responsive polymers, such that the polymer matrix is or becomes hydrophobic and the water flow and the flow of hydrophilic molecules preferably goes through the protein/peptide channels and not the polymer matrix.

In addition, the present invention relates to possibilities of use of the thin-film membrane according to the invention. In particular, the thin-film membrane is suitable for separation of molecules, in particular according to charge, size, chemical composition, intermolecular interactions and chirality, preferably for the separation of enantiomers or for water treatment, in particular for water desalination.

The present invention is represented in more detail with reference to the subsequent embodiments and explanations without restricting the invention to the illustrated special embodiments.

There are hereby shown:

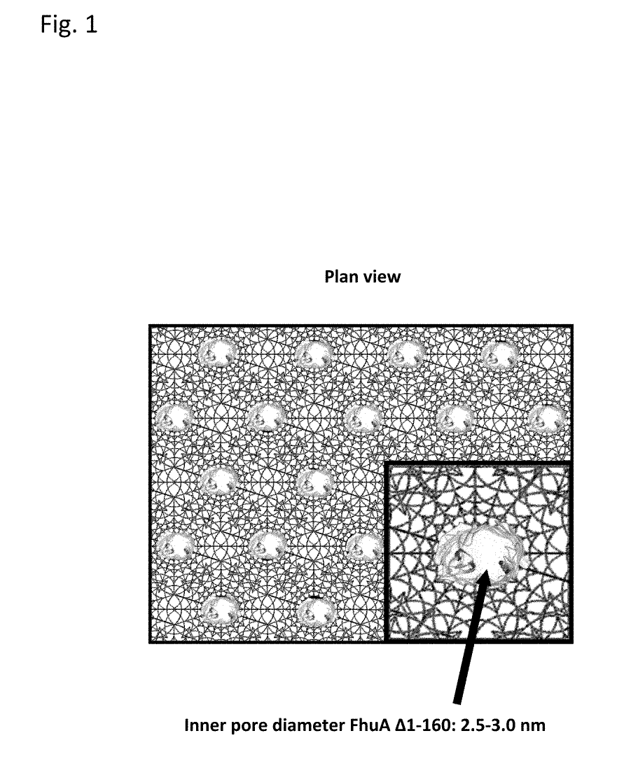

FIG. 1 a schematic view on a planar membrane according to the present invention

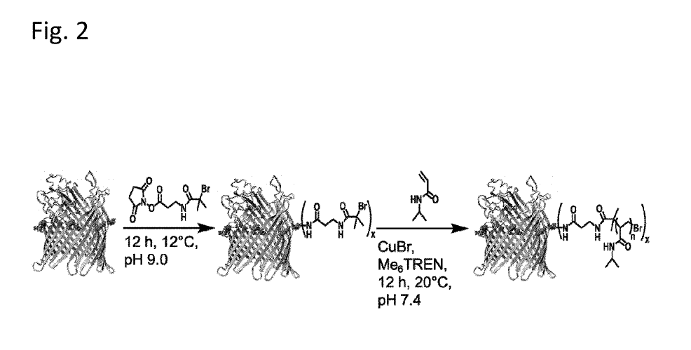

FIG. 2 a synthesis possibility, by way of example, for producing a thin-film membrane according to the invention

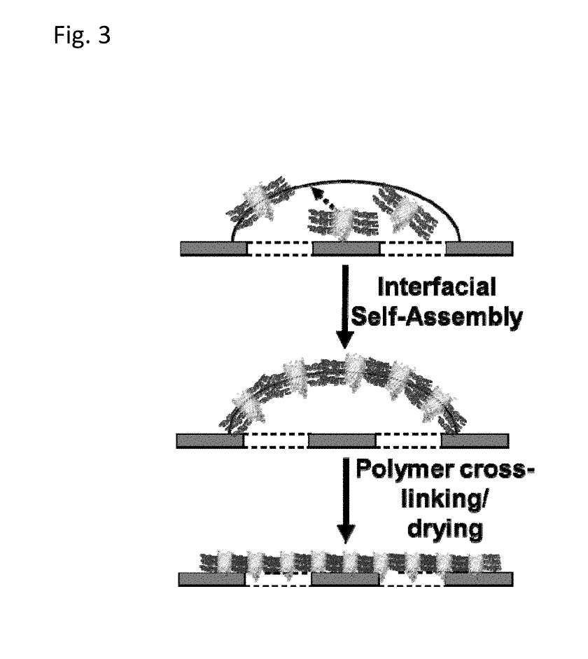

FIG. 3 the principles for producing a thin-film membrane according to the invention on a porous carrier surface

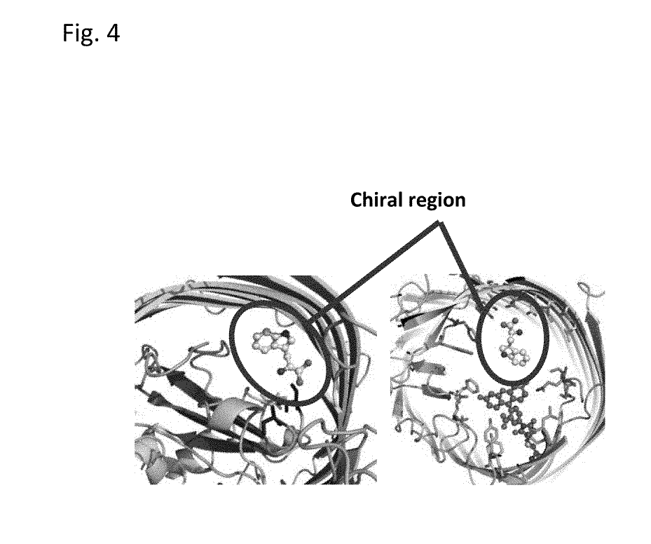

FIG. 4 a view in a modified channel of a pore-forming protein or peptide of a membrane according to the invention for the application possibility for separation of enantiomer mixtures.

No method has existed to date for producing membranes with high density of pore-forming proteins or peptides, in particular transmembrane proteins which form continuous pores in the thin-film membrane with exactly uniform size in the range of a few nm, which method is based on a different way from using the uniformity of pore-forming proteins or peptides.

In addition, no membranes exist in which the pore-forming proteins and peptides are bonded covalently so that continuous pores are formed in the thin-film membrane.

This defect is eliminated by the present invention.

FIG. 1 shows a plan view on a planar thin-film membrane according to the present invention, with high density of linked pore-forming proteins or peptides. The pore-forming proteins and peptides thereby typically have a pore internal diameter of 1 to 3 nm and are bonded together covalently via a network of polymers. As an alternative hereto (not illustrated), the pore-forming proteins and peptides can also be linked together directly via bi- or multifunctional, monomolecular linkers.

Membranes, in which pore-forming proteins and peptides such as FhuA sit with high density with an open channel of approx. 1-3 nm diameter can be produced in two different ways: by crosslinking the polymer chains of protein/peptide copolymer conjugates (FIG. 2) and also by direct crosslinking of the pore-forming proteins and peptides with a bi- or multifunctional linker.

The preparation of protein/peptide polymer conjugates is described numerous times with globular and soluble proteins and also viruses (Polym. Chem. 2015, 6, 5143 and Chem. Commun. 2011, 47, 2212 give an overview). The conjugate synthesis with pore-forming proteins or peptides by the grafting from approach is however not known. The used grafting from has the advantage over different strategies for synthesis of protein/peptide polymer conjugates that a comparatively high number of polymer chains can be grown from the protein/peptide surface.

FIG. 2 shows, by way of example, the synthesis of protein/peptide polymer conjugates by binding-on an initiator unit to the amino acid radicals (left) and subsequent polymer synthesis of the protein/peptide surface. In the example, the copolymerisation of N-isopropylacrylamide (NIPAAm) with approx. 5% 2-(dimethylmaleimido)-N-ethylacrylamide (DMIAAm) is shown. The side chains of DMIAAm can be crosslinked in a [2+2] cycloaddition using UV light. The crosslinking effected by the UV light thereby produces the final membrane.

For the synthesis shown in FIG. 2, firstly an initiator for the polymerisation is bonded to an amino acid radical, in the example to the lysin radicals of FhuA. The subsequent polymerisation is shown by NIPAAm, but can also be effected with other monomers. In order to make possible the crosslinking of the polymer chains, a corresponding comonomer such as DMIAAm at approx. 5% is added. The maleimide units can link polymer chains by irradiation with UV light in a [2+2] cycloaddition.

Pore-forming proteins and peptides have an intrinsic interface activity due to their hydrophilic and hydrophobic regions. In contrast to unmodified proteins, the interface activity of protein/peptide polymer conjugates is generally again significantly higher. The conjugates self-assemble at the air/water interface from greatly diluted solution and can be bonded by linking the polymer chains to each other to form a stable, thin membrane. After evaporation of the water phase, this membrane is situated in a planar manner on the used support.

In this connection, FIG. 3 shows, by way of example, the principle of self-assembly of membrane protein-polymer conjugates at the water-air interface and linking of the polymer chains. After evaporation of the water, the membrane sits on a porous carrier.

In addition to the linking of covalently bonded polymer chains, pore-forming proteins and peptides can also be linked directly by crosslinkers. The crosslinkers must have at least two functionalities which are separated by a short spacer and react with amino acid radicals. One example is glutaraldehyde, which reacts with the amino groups of the amino acid lysin. In this way, the spacing of the pore-forming proteins or peptides in the membrane is again smaller and the greatest possible density of the protein pores can be achieved.

One possible application of such membranes is use for separation of enantiomer mixtures. The components are smaller than the channel diameter in order to ensure a throughflow of the enantiomers, preferably only one enantiomer being allowed to pass through the channel. This is achieved by chemical and/or genetic modifications in the channel interior, which modifications interact differently with the different enantiomers. Possible substance classes are enantiomeric amino acids but also amines, epoxides and terpenes. FIG. 4 shows, by way of example, tryptophan in the channel for chiral separation of amino acids.

FIG. 4 thereby shows various strategies for FhuA Engineering in order A) to separate sterically non-demanding (FhuA Wildtype) and B) sterically demanding (FhuA Δ1-159 with fluorescein marking) enantiomer mixtures (cross-sectional view of Fhua).

Commercial membranes with covalently bonded pore-forming proteins or peptides as pores are a new class of membranes. The main field of application is separations of all types. By means of the uniform size of the protein/peptide channels, firstly a separation with a precision not achieved to date is possible because of a size exclusion. Particles, the size of which is below the 2-3 nm diameter of the pores, can pass through the membrane, whilst larger particles are held back. In addition, the low throughflow resistance makes possible flows which have not been achieved to date via the membrane with low energy requirement. By introducing functionalities into the channel interior, separations can be implemented which go beyond purely a size exclusion. An essential field of application resides here in the separation of an enantiomer mixture. The membranes therefore allow a new approach for producing enantiomer-pure compounds, which approach offers a significant advantage with respect to costs and efficiency relative to existing methods.

1-18. (canceled)

19. A porous thin-film membrane made up of covalently crosslinked, pore-forming proteins or peptides forming continuous pores in the thin-film membrane.

20. The porous thin-film membrane according to claim 19, which has a pore density in the range of 1·10⁸ channels/cm² to 1·10¹³ channels/cm².

21. The porous thin-film membrane according to claim 19, whose pore size is in the range of 0.1 to 20 nm.

22. The porous thin-film membrane according to claim 19, in which the pore size of all the pores is essentially identical.

23. The porous thin-film membrane according to claim 19, wherein the thickness of the porous thin-film membrane is between 1 and 100 nm.

24. The porous thin-film membrane according to claim 19, wherein the pore-forming proteins or peptides are selected from the group consisting of transmembrane proteins and proteins or peptides of the TCDB classification categories TC #1-9.

25. The porous thin-film membrane according to claim 19, which is produced by crosslinking a protein/peptide polymer conjugate having crosslinkable functionalities.

26. The porous thin-film membrane according to claim 25, wherein the protein/peptide polymer conjugate is a conjugate of a polymer selected from the group consisting of polymers or statistical copolymers with groups which are crosslinkable by radiation, radical reactions, or click-chemical reactions.

27. The porous thin-film membrane according to claim 26, wherein the polymer is selected from the group consisting of poly(co)acrylamides and poly(co)acrylates with substituents which are crosslinkable by radiation, radical reactions, or click-chemical reactions.

28. The porous thin-film membrane according to claim 26, wherein the polymer is selected from the group consisting of poly(co)(N-isopropylacrylamide)(2-(dimethylmaleimido)-N-(ethylacrylamide)), poly(co)(N-isopropylacrylamide)(3,4-dimethylmaleinimidobutylacrylate), poly(co)(N,N-dimethylaminoethylmethacrylate)(3,4-dimethylmaleinimidobutylmethacrylate), and poly(co)(vinylcaprolactam)(3,4-dimethylmaleinimidobutylacrylate).

29. The porous thin-film membrane according to claim 27, wherein the polymers of the protein/peptide polymer conjugates are or become bonded covalently to the pore-forming protein or peptide by an initiator, a chain-transfer agent, or a catalyst, which is bonded covalently to the pore-forming protein or peptide.

30. The porous thin-film membrane according to claim 19, which is produced by crosslinking of amino acid radicals or glycosylating groups of the pore-forming proteins or peptides by at least one bi- or multifunctional crosslinker.

31. The porous thin-film membrane according to claim 30, wherein the crosslinker is selected from the group consisting of dialdehydes, dicarboxylic acids, N-hydroxysuccinimide-activated dicarboxylic acids, diacid halogenides, diamines, and diiso(thio)cyanates.

32. The porous thin-film membrane according to claim 19, wherein the pore-forming proteins or peptides are functionalised on the inner pore surface.

33. The porous thin-film membrane according to claim 19, wherein the thin-film membrane is on a porous carrier structure.

34. A method for producing a porous thin-film membrane according to claim 19, which involves crosslinking the pore-forming proteins or peptides to each other covalently.

35. The method according to claim 34, wherein
a) at least one initiator, chain-transfer agent, or catalyst for ROMP is bonded covalently to each pore-forming protein or peptide via at least one amino acid radical,
b) the initiator-, chain-transfer agent- or catalyst-functionalised, pore-forming protein or peptide is reacted with monomers, and protein/peptide polymer conjugates are formed, in which polymers or statistical copolymers with groups which are crosslinkable by radiation, radical reactions or click-chemical reactions are formed, and
c) the protein/peptide polymer conjugates is crosslinked.

36. A method of separating molecules comprising contacting the porous thin-film membrane according to claim 19 with the molecules and isolatng the molecules from one another according to charge, size, chemical composition, intermolecular interactions or chirality.
